(19) United States
(12) Patent Application Publication
(10) Pub. No.: US 2003/0084441 A1
(43) Pub. Date: May 1, 2003

(54) System and method for ITV data automation via a broadcast traffic and scheduling system

(76) Inventor: Richard C. Hunt, Los Angeles, CA (US)

Correspondence Address: CHRISTIE, PARKER & HALE, LLP, P.O. BOX 7068, PASADENA, CA, 91109-7068, US

(21) Appl. No.: 10/286,128

(22) Filed: Oct. 31, 2002

Related U.S. Application Data
(60) Provisional application No. 60/335,665, filed on Oct. 31, 2001.

(51) Int. Cl. H04N 7/025; H04N 7/10; H04N 7/16

(52) U.S. Cl. 725/32; 725/36; 725/146

(57) ABSTRACT

A system and method for ITV data automation. A broadcast traffic and scheduling system generates a schedule of television programs to be broadcast in a day. A broadcast automation system translates the schedule of programs into an automation playlist. The playlist may also include the ITV events to be encoded into the broadcast program. The automation playlist is provided to an ITV automation unit which encodes ITV data associated with the ITV events into the broadcast signal in accordance with the playlist. Alternatively, the ITV automation unit may receive the ITV events/data directly from the broadcast traffic and scheduling system, independently of the automation playlist. In this manner, the ITV events need not be tied to the playlist of television programs, allowing the insertion of ITV events to be more flexible and dynamic.

### CROSS-REFERENCE TO RELATED APPLICATION(S)

This application claims the benefit of U.S. Provisional Patent application No. 60/335,665, filed on Oct. 31, 2001, the content of which is incorporated herein by reference.

### FIELD OF THE INVENTION

The present invention relates generally to interactive television production, encoding, and broadcasting systems and methods, and more particularly, to automating ITV data insertion via a broadcast traffic and scheduling system.

### BACKGROUND OF THE INVENTION

Interactive television (ITV) combines conventional television with additional interactive content to present a viewer with an enhanced version of a television program or commercial. Typically, the interactive content is in some way related to the television program that is being viewed, such as biographical information about one of the actors in the program, additional information about a topic covered in the program, and the like.

In order to allow a viewer to experience an enhanced television program, a broadcaster encodes the television program with ITV data and broadcasts the encoded television program to the viewers. The ITV data may take many forms, such as, for example, HTML, XML, JAVA, or JAVA Script commands. If the receiving viewer's television system is equipped with an ITV receiver, the ITV receiver may decode the embedded ITV data for accessing the associated interactive content or performing an action indicated by the command.

In traditional ITV data encoding, an ITV producer watches a pre-recorded TV program and manually controls an ITV encoder to insert ITV links and triggers onto a physical broadcast tape prior to its broadcast. Such a method is tedious and requires relatively large amounts of the producer's time.

Furthermore, when the ITV data is encoded onto a physical tape, production changes may generally not be made to the tape without redesigning and editing the interactive data. The encoding of ITV data onto a physical tape is therefore especially disadvantageous for ITV programming of advertisements and commercials where each commercial is generally recorded on a different physical tape. The trafficking of these physical tapes may make it very costly and time-consuming to embed the ITV data.

Thus, it is desirable to have a system and method of automating the insertion of the ITV data (or at least a portion thereof) in the video signal, thereby at least reducing the complete reliance on an ITV producer. It is further desirable that the insertion of the ITV data be dynamic, and not necessarily coupled to the actual broadcast tape or content of such tape.

### SUMMARY OF THE INVENTION

According to one embodiment of the invention, an interactive television (ITV) system includes a means for receiving a playlist of ITV events; an automation unit coupled to the means for receiving, the automation unit obtaining ITV data associated with the ITV events in the playlist; and an encoder coupled to the automation unit, the encoder configured to encode the ITV data into a broadcast signal in accordance with the playlist of ITV events.

According to another embodiment of the invention an interactive television system includes a means for receiving a playlist of ITV events; means for retrieving from the playlist timing information associated with the ITV events; and means for coordinating at least one of the ITV events with a television program based on the retrieved timing information.

In a further embodiment of the invention, an interactive television system is configured to generate a playlist of television programs to be broadcast during a particular period of time. The ITV system includes an ITV automation unit receiving information on an ITV event and generating an encoder command in response, the information on the ITV event being transmitted to the ITV automation unit independently of the playlist of television programs; and an encoder coupled to the ITV automation unit, the encoder encoding ITV data associated with the ITV event into a broadcast signal in response to the encoder command.

In yet another embodiment of the invention, the ITV system includes a means for receiving information on an ITV event independently of the playlist of television programs; means for generating a command associated with the ITV event; and means for synchronizing the ITV event with a television program based on the command.

In a further embodiment of the invention, a method for providing an interactive television program includes generating a playlist of ITV events; obtaining ITV data associated with the ITV events; and encoding the ITV data into a broadcast signal in accordance with the playlist of ITV events.

In another embodiment, a method for providing an interactive television program includes receiving a playlist of ITV events; retrieving from the playlist timing information associated with the ITV events; and coordinating at least one of the ITV events with a television program based on the retrieved timing information.

In an additional embodiment, a method for providing an ITV television program includes receiving information on an ITV event independently of the playlist of television programs; generating a command associated with the ITV event; and synchronizing the ITV event with a television program based on the command.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a schematic block diagram of an ITV system according to one embodiment of the invention;

FIG. 2 is a schematic block diagram of an ITV system according to an alternative embodiment of the invention;

FIG. 3 illustrates an exemplary use of the ITV system of FIG. 2 according to one embodiment of the invention;

FIG. 4 illustrates an exemplary use of the ITV system of FIG. 2 according to an alternative embodiment of the invention;

FIG. 5 illustrates another exemplary use of the ITV system of FIG. 2 according to another embodiment of the invention; and

FIG. 6 is yet another exemplary use of the ITV system of FIG. 2 according to an embodiment of the invention.

### DETAILED DESCRIPTION OF THE INVENTION

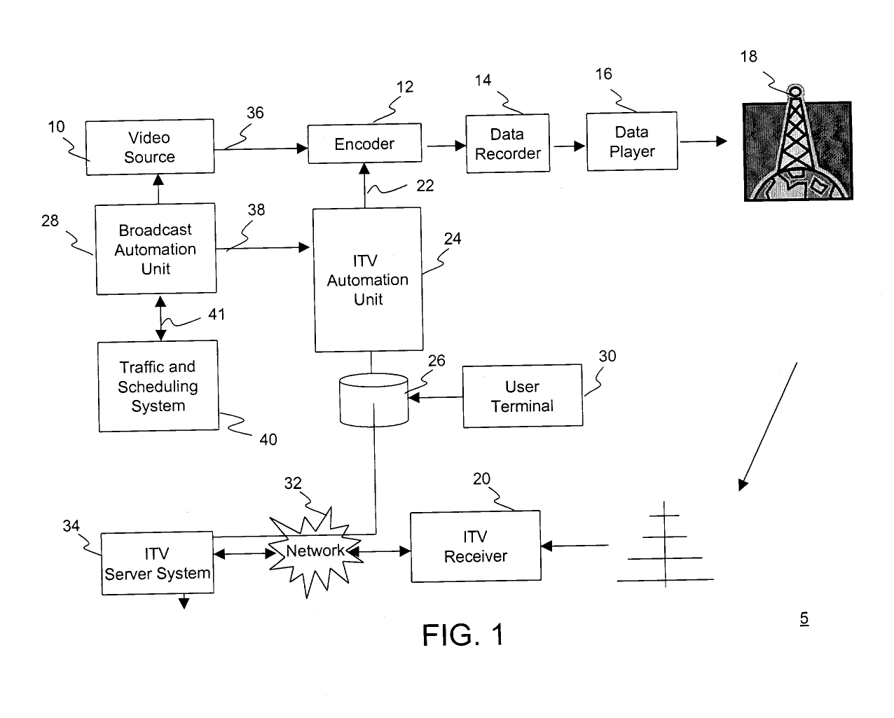

FIG. 1 is a schematic block diagram of an ITV system 5 according to one embodiment of the invention. The ITV system 5 illustrated in FIG. 1 includes an encoder 12 coupled to a video source 10 over a serial or network link 36, such as for example, a local area network (LAN) or wide area network (WAN) link. The video source 10 provides live or recorded video programs to the encoder for embedding ITV data into the video program. The ITV data may be embedded, for example, in the vertical blanking interval (VBI) (for example, line 21), or an MPEG 2 private data field (or a similar field of additional video formats) of the video portion of the program. The ITV data may be triggers, HTTP, XML, JAVA, or JAVA SCRIPT commands, URLs, and/or other type of ITV links, triggers, data sources, timing information, and data conventional in the art.

The encoder 12 may be an encoder conventional in the art, such as, for example, a DV2000 universal data encoder or ITV Injector, marketed by Ultech LLC, Middlebury, Conn. The video source 10 may be a camera, VCR, betacam, DVD player, PC, CD-ROM player, or any other device capable of delivering a video feed to the encoder 12.

The ITV system 5 further includes a traffic and scheduling system 40 coupled to a broadcast automation unit 28 over serial or network link 41. The traffic and scheduling system 40 provides a master broadcast schedule for the day. The master broadcast schedule may be generated as a word document, a spreadsheet, or the like. The schedule may include information of the particular programs to be broadcast, the advertisements to be run during those programs, the ITV events that are to occur, and the like.

According to one embodiment of the invention, the master broadcast schedule is translated into an automation schedule by the broadcast automation unit 28. The broadcast automation unit 28 may perform the translation in any manner that is conventional in the art. The automation schedule, which is also referred to as an automation playlist, includes commands and timing information to be issued to various play sources, switching units, and other broadcast equipment, for execution by such equipment.

According to one embodiment of the invention, the commands in the playlist also include ITV events to be encoded into a broadcast signal. The ITV events may be used to retrieve and display particular types of ITV content on the viewer's display monitor. The ITV events may also allow a viewer to play along with a game show, purchase products, and/or interact otherwise with the enhanced television program.

The broadcast automation unit 28 periodically forwards a portion of a running playlist to the ITV automation unit 24 via a serial or network link 38. The ITV automation unit 24 may take the form of a processor residing in a dedicated, stand-alone computer, in the encoder 12, or in one or more ITV-related equipment.

The ITV automation unit 24 processes the playlist data and automatically computes the ITV links and data to be encoded into the broadcast signal in accordance to the playlist. According to one embodiment of the invention, each playlist command is associated with a descriptor such as, for example, a start time code, event identifier (key), and the like. The ITV automation unit 24 translates the playlist commands into encoder commands that are to be understood by the encoder 12. An encoder command may include a command code and optional parameter data, such as, for example, ITV data in the form of links and triggers.

The ITV automation unit 24 reads and processes the playlist data and retrieves the corresponding encoder command codes and appropriate ITV data from an ITV command and content database 26 for automatically encoding the ITV data into the broadcast signal according to the time code information in the playlist. An operator may define a list of encoder commands associated with the playlist commands that may be expected by entering encoder command files into the ITV command and content database 26 using a data entry program resident in a user terminal 30. The encoder command files may be associated with a broadcaster's ID such as commercials so that when a broadcaster ID is encountered in a playlist, the ITV automation unit 24 automatically retrieves the associated encoder commands and generates the enhancements in real-time based on the program's time code.

The ITV automation unit 24 feeds the encoder commands to the data encoder 12 over link 22. Link 22 may allow for a serial, LAN, or WAN communication between the ITV automation unit 24 and encoder 12. According to one embodiment of the invention, the encoder commands are transmitted over a LAN application programming interface (API). Details on the API commands used for communicating with the encoder is described in further detail in U.S. patent application Ser. No. 10/208,362 entitled “Command Protocol For Interactive TV Production Tools,” filed on Jul. 29, 2002 (attorney docket 48800/JEC/G476), the content of which is incorporated herein by reference.

In an alternative embodiment, the ITV automation unit 24 translates the playlist commands into commands for an ITV server system 34 that in turn communicates with end-user devices or other components of the ITV system to coordinate the ITV content with the TV program. This embodiment is also referred to as a push/open socket model.

In another embodiment, the ITV automation unit 24 passes to the ITV server system 34 the time code information contained in the playlist. The ITV server system 34 identifies the synchronized ITV content that is associated with the time code of the program and feeds back the appropriate data and commands to the ITV automation unit 24. The ITV automation unit 24 forwards the received data and commands to the encoder 12 for encoding the corresponding data/content.

The encoder 12 outputs the video program with the encoded ITV data to a data recorder 14 for recording for subsequent broadcast. At an appropriate time, the video program with the embedded ITV data is broadcast via a data player 16 and a broadcast station 18. An ITV receiver 20 in a viewer's home receives and decodes the ITV data contained in the television program. The ITV receiver 20 may take the form of a set-top box, digital cable box, television with embedded set-top box functionality, or other suitable device with ITV related software, middleware, and/or hardware that is conventional in the art.

Typically, when a television program with available interactive TV content is received, the viewer is given an option to receive the enhanced experience. In a typical scenario, if the viewer chooses the enhancements using a user input device such as a remote control unit, keypad, keyboard, or joystick, the ITV receiver 20 establishes a connection to a network 32 if a connection is not already made. The network 32 may be a wide area network, cable network, wireless network, or the like. The ITV receiver connects to the ITV server system 34 based on data such as a location (for example, a URL) embedded in the television program, and retrieves ITV content from the server for producing the enhanced experience.

In an alternative embodiment of the invention, the ITV receiver 20 receives ITV content from the ITV server system 34 directly. In this scenario, the ITV automation unit 24 ensures timing coordination of the content published by the ITV server system 34 and the TV program broadcast.

As an ITV viewer interacts with the interactive program, the interaction information is transmitted back to the ITV server system 34, a head end, or any other interested organization, over a back channel. The back channel may take the form of any type of communication channel known in the art, such as, for example, the network connection 32, a separate telephone connection, wireless connection, or the like. The back channel may also be used to receive ITV commands, software updates, and other types of data from the head end, an ITV producer, or the like.

A person skilled in the art should appreciate that with the ITV system illustrated in FIG. 1, ITV data no longer needs to be encoded onto a physical broadcast tape before the time of the broadcast. Instead, ITV content may be associated with a broadcast program in an automated, cost-effective fashion based on the playlist provided by the broadcast automation unit 28. This may be especially advantageous for ITV programming for advertisements and commercials where each commercial may be stored on a different physical tape. With the ITV automation unit 24, ITV content may be automatically associated with the commercial on each of tape without having to physically encode the ITV data onto the tapes in advance.

Furthermore, the ITV system of FIG. 1 allows tapes to be edited or re-edited without the requirement of costly reproduction and encoding of the ITV data on each tape. The actual ITV data and timing information may also be changed cost-effectively over time or across distribution systems. For instance, an advertisement for an automobile may have an associated ITV programming in July that offers a 0% down payment option. The same advertisement, however, may have no associated ITV programming if run in August, and an ITV programming that offers a 10% down payment option if run in September. The ITV data provided by the same advertisement could also offer a different look and feel of the interactivity based on the broadcast station (CBS or ABC) running the ad. The ITV system of FIG. 1 therefore provides flexibility and cost-effectiveness to ITV programming that was generally not available to systems that would permanently encode the ITV data to the physical tapes in advance of their broadcast.

In the embodiment illustrated in FIG. 1, however, the ITV data encoded into the broadcast signal is pre-determined by the playlist that is provided by the broadcast automation unit 28. Once the playlist has been generated, there is generally no provision for additional interactive functions related to the playlist. Furthermore, because the playlist is defined in terms of tape time, that is, the total running time of a taped program, the ITV data inserted into the program is also tied to the tape time and hence, to the particular television program content of such television program.

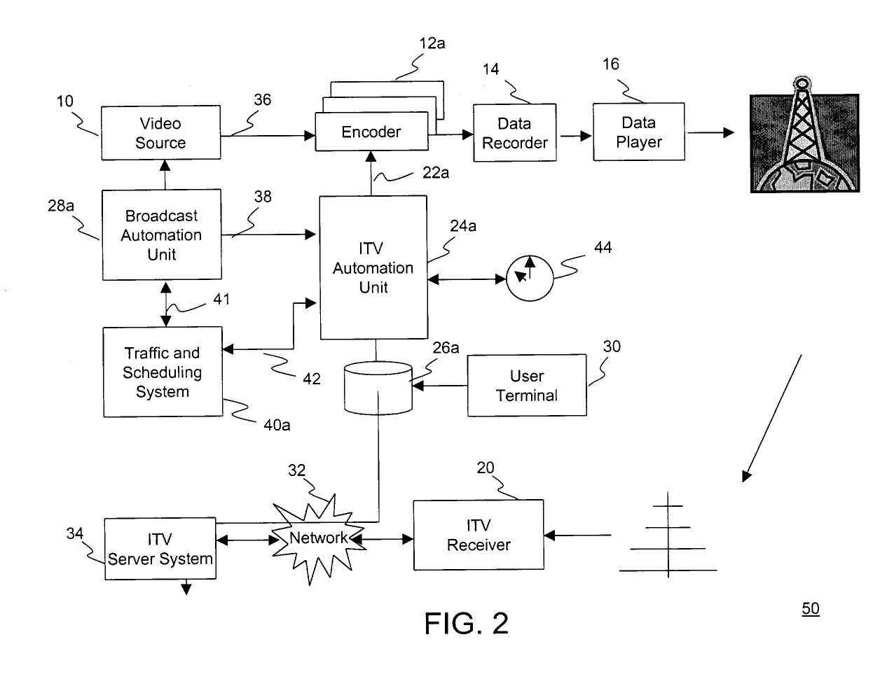

FIG. 2 is a schematic block diagram of an ITV system 50 according to an alternative embodiment of the invention. Unlike the ITV system 5 of FIG. 1, the ITV system 50 illustrated in FIG. 2 allows for dynamic ITV data insertion that is independent of any playlist defining a day's program schedule.

The ITV system 50 includes an ITV automation unit 24a that may be similar to the ITV automation unit 24 of FIG. 1. However, the ITV automation unit 24a of FIG. 2 is configured to interact directly with a traffic and scheduling database 40a over a serial or network link 42 such as, for example, a structured query language (SQL) link. This interaction may be in addition or in lieu of the interaction with the broadcast automation unit 28a.

As the traffic and scheduling system 40 of FIG. 1, the traffic and scheduling system 40a of FIG. 2 provides a master broadcast schedule for use by the broadcast automation unit 28a to generate a playlist for the day. The traffic and scheduling system 40a however includes additional functionality for interacting directly with the ITV automation unit 24a. This interaction allows ITV event commands to be transmitted directly to the ITV automation unit instead of incorporating them into a playlist of scheduled programming, allowing the broadcast automation unit to be bypassed for purposes of such transmission. Thus, ITV data may therefore be scheduled dynamically in a manner that is independent of the programming in the playlist and without requiring synchronism with such programming. Furthermore, ITV content may be changed dynamically in a flexible manner based on different types of viewer interactions, habits, interests, and the like.

The traffic and scheduling system 40a transmits an ITV event that would otherwise be provided as part of the playlist, directly to the ITV automation unit 24a via link 42. The ITV automation unit 24a converts the ITV event to an encoder command and transmits it to the encoder 12 for encoding the ITV event.

The traffic and scheduling system 40a also provides the actual ITV data, in the form of links, triggers, and the like, to be inserted into a transmitted signal. This allows broadcasters to treat the ITV data as data assets in the same manner as video and audio assets. Specifically, the broadcasters may use the ITV data as a billable source of revenue that is scheduled and managed by the same departments and organizations responsible for billable audio and video content. A broadcaster may now schedule and receive revenue for providing the ITV data. For example, a broadcaster may now charge an X amount of dollars for providing a link to a Coca-cola® website during the Super Bowl to allow consumers to access the link and purchase products from the website at a discounted price during the game.

In addition to providing links and triggers to the ITV automation unit 24a, the traffic and scheduling system 40a provides conditional events, wall time events, additional ITV content, live ITV content, other timed events, ITV billing and verification information, and the like, directly to the ITV automation unit 24a.

Conditional events are ITV events that may be changed, such as, for example, based on viewer interaction with the ITV content. Thus, a first type of ITV event may be presented to the viewer based on a first viewer interaction while a second type of ITV event may be presented based on a second viewer interaction.

Wall time events, are events that are related to the time of the day, referred to as a wall time 44, as opposed to a tape time. The insertion of ITV data based on the wall time allows it to be more dynamic than the insertion based on tape time, because the insertion is no longer associated with a playlist. A wall time event may be, for instance, the running of a viewer poll during a particular time period, for example, from 8:00am to 5:00pm, regardless of the actual program content being broadcast during this time. As another example, a wall time event may be an advertisement of a future program to be broadcast. The advertisement may provide the viewer an option to schedule a recording of the program as soon as it is broadcast.

Additional ITV content may also be provided by the traffic and scheduling system 40a without having to associate it with a particular playlist. For example, subscribers to a sports news service may receive daily updates, investors may receive periodic quotes, and the like, via links provided by the traffic and scheduling system directly to the ITV automation unit 24a. The subscribers may indicate when they would like to receive such ITV content, and the broadcasters may accommodate them based on their request. For example, the subscribers may indicate a particular wall time 44 in which the content is to be delivered. Based on such a request, the traffic and scheduling system 40 creates a wall time event for the desired content and transmits it to the ITV automation unit 24a. Upon the detection of the indicated wall time, the ITV automation unit inserts the appropriate link to the video program for providing the desired content to the subscribers.

Encoding/generation of live ITV content may be especially relevant for live TV shows such as sports, reality shows, and news. In this case, the ITV automation unit 24a may receive direct commands for on-the-fly created ITV content.

The direct connection between the traffic and scheduling system 40a and the ITV automation unit 24a also facilitates the insertion of timed events. A timed event may be an event that is active for a limited amount of time, such as links to stimulate impulse buying. Timed links may be sent opportunistically by the broadcaster based on the wall time 44 to capture audience and/or revenue, without being confined to a defined playlist.

ITV billing verification may also be facilitated in the embodiment illustrated in FIG. 2. As the ITV content is taken from the traffic and scheduling system 40a and inserted into a broadcast signal by the ITV automation unit 24a, the verification that the ITV content has been broadcast can be conveniently sent back to the traffic and scheduling system 40a via any mechanism conventional in the art.

The ability to provide data to the ITV automation unit 24a independently from the playlist also allows the traffic and scheduling system 40a to control multiple signals, such as signals provided by a network and its affiliates. Because a playlist is generally limited to a single broadcast signal, a playlist with ITV commands to be inserted in more than one broadcast signal requires the creation of multiple playlists, one for each broadcast signal. However, by allowing the traffic and scheduling system 40a to transmit ITV content directly to the ITV automation unit without having to include it in a playlist, the traffic and scheduling system may transmit the ITV content to the ITV automation unit only once, while still allowing the ITV content to be inserted into multiple signals.

A separate encoder 12a may be provided for each signal for inserting the ITV content into the signal. The ITV content may then be transmitted by the ITV automation unit 24a to the encoders over a network link 22a such as a TCP/IP connection. The encoders may also be located at a variety of disparate geographic locations.

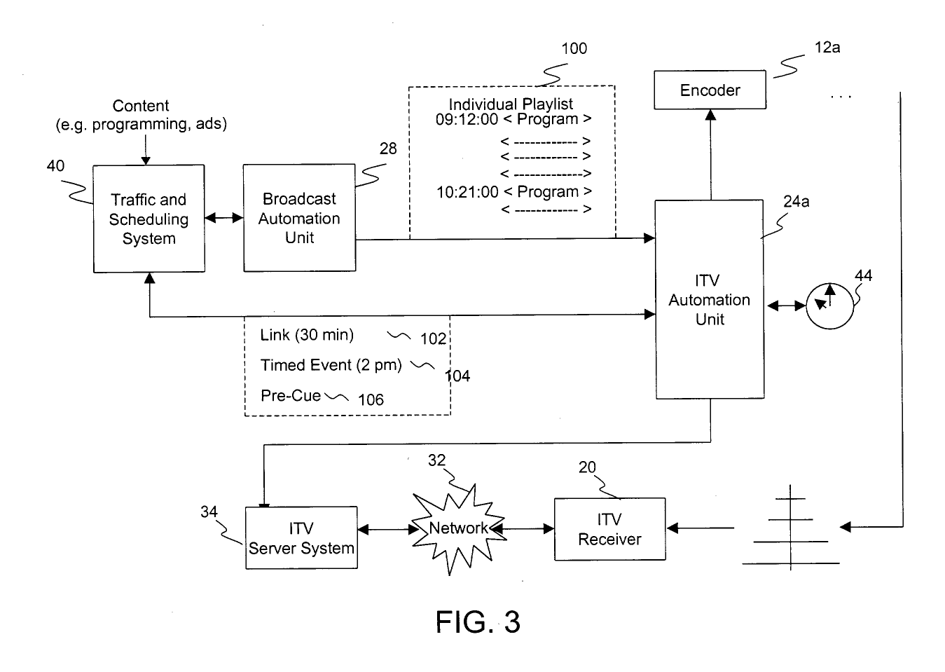

FIG. 3 illustrates an exemplary use of the ITV system 50 of FIG. 2 according to one embodiment of the invention. According to this example, the ITV automation unit 24a receives both an individual playlist 100 from the broadcast automation unit 28 as well as a link 102, timed event 104, and pre-cue event 106, from the traffic and scheduling system 40. The timed event 104 is the insertion of the link 102 in the broadcast signal starting at 2:00pm over a period of 30 minutes. Because the timed event 104 is not provided as part of the individual playlist 100, it may be defined in terms of the wall time 44 and not the tape time associated with a particular program. When the ITV automation unit 24a detects that the wall time 44 has reached the command time, the unit causes the encoder 12 to dynamically encode the link 102 for the indicated period of time.

The link 102 may be used in a variety of ways. For illustrative purposes, the link 102 informs a viewer that content is available on the ITV server system 34 for retrieval. The ITV automation unit 24a provides the pre-cue signal 106 to the ITV server system to allow it to preemptively retrieve the necessary content prior to the time when the link 102 is provided to the viewer. The pre-cue signal 106 may be transmitted over the network connection 32 or a direct link (not shown) between the ITV automation unit 24a and the ITV server system 34. In this manner, the content associated with the link will be made available in the ITV server system 34 if the viewer decides to select the displayed link.

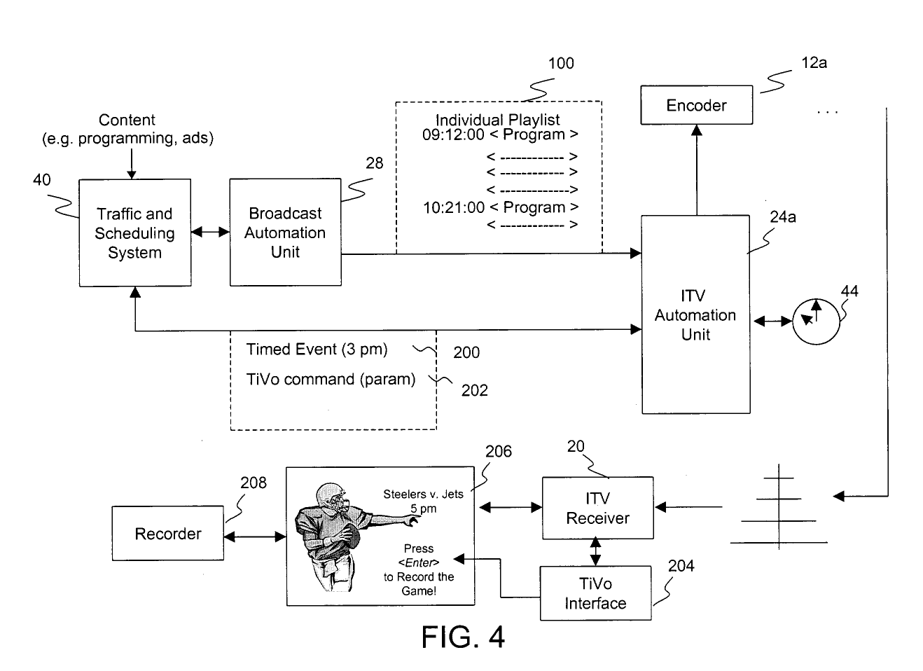

FIG. 4 illustrates an exemplary use of the ITV system 50 of FIG. 2 according to an alternative embodiment of the invention. According to this example, the traffic and scheduling system 40 transmits TiVo® commands and associated parameters 202 as a timed event 200 to the ITV automation unit. For example, the TiVo commands may allow the display of an advertisement for an upcoming football game between the Steelers and the Jets, and allow the viewer to schedule a recorder 208 to record the game when the game is broadcast.

When the wall time reaches the time indicated for transmitting the TiVo® commands, the encoder 12a encodes the command into the broadcast signal. The ITV receiver 20 receives the encoded broadcast signal and provides it to a TiVo® interface 204. The interface 204 provides an interactive on-screen prompt on the viewer's television set 206, allowing the viewer to record the game. The prompt may disappear when the advertisement for the game is over after a predetermined period of time. Alternatively, if the viewer has shown a previous interest in football, such as, for example, if the viewer has taped football games before, the interface 204 may periodically remind the viewer that he or she may record the game. The same system may be used for any device that can utilize this technology, whether a TiVo®, a DVR, a PVR, console, PC or other similar device (including set-top boxes which notify a server system of the desire to record).

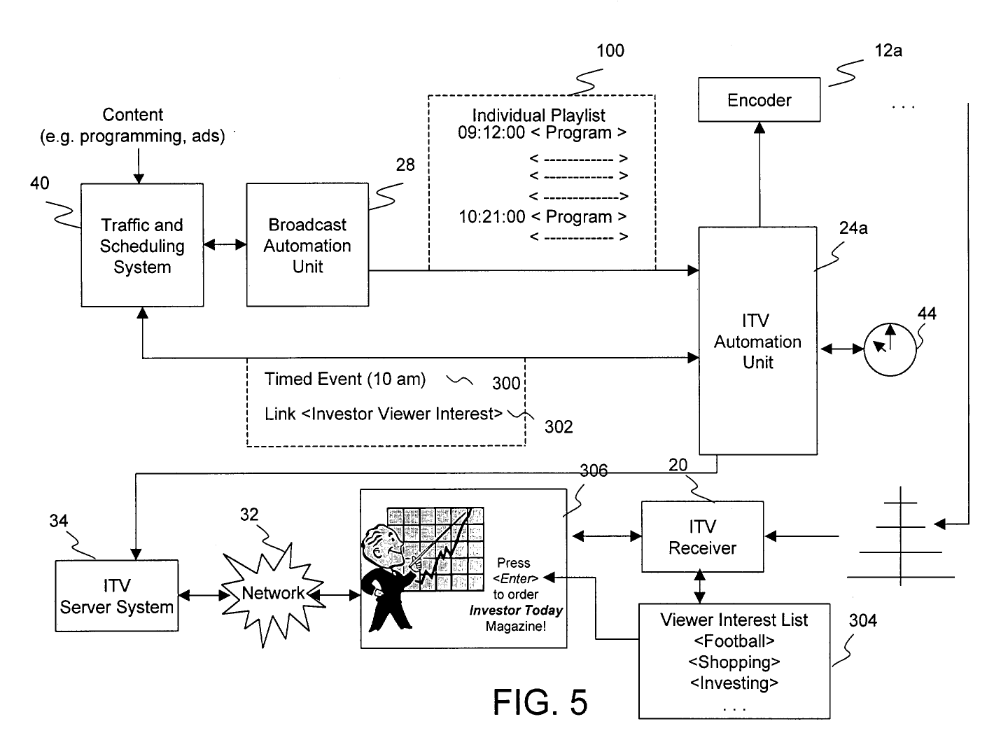

FIG. 5 illustrates another exemplary use of the ITV system 50 of FIG. 2 according to another embodiment of the invention. The traffic and scheduling system 40 transmits to the ITV automation unit 24a a timed event 300 and link 302. The link in the illustrated example provides an advertisement for an “Investor Today” magazine on the viewer's television 306, and allows the viewer to order the magazine at a discounted price.

The timed link may be sent opportunistically by the broadcaster at different times of the day to capture audience and/or revenue. For example, the link may be provided during a commercial for the “INVESTOR TODAY” magazine or during a financial program. Upon an indication that the viewer wants to purchase the magazine, the order is transmitted over the network connection 32 to the ITV server system 34 for completion of the order.

Other timed links may also be sent to the viewer based on an interest list 304 maintained for the viewer. The interest list 304 may contain information about the viewer's particular interests, hobbies, viewing habits, and the like. This information may be used to select a particular type of advertisement to be displayed to the viewer. For example, the traffic and scheduling system 40 transmit a generic advertisement link to be inserted into the broadcast signal. Upon receipt of such generic advertisement link, the ITV receiver 20 may select the actual type of advertisement to be displayed to the viewer based on the viewer's interest list 304. Thus, if the viewer's interest list indicates football as an interest, an advertisement on football events and products may be provided to the viewer upon the receipt of the general advertisement link. This system provides a very cost-effective and efficient way of providing more valuable advertising or content to a viewer by taking advantage of the interactive system. The interest list may be user defined, computer generated or may come from a database of information or history on the user.

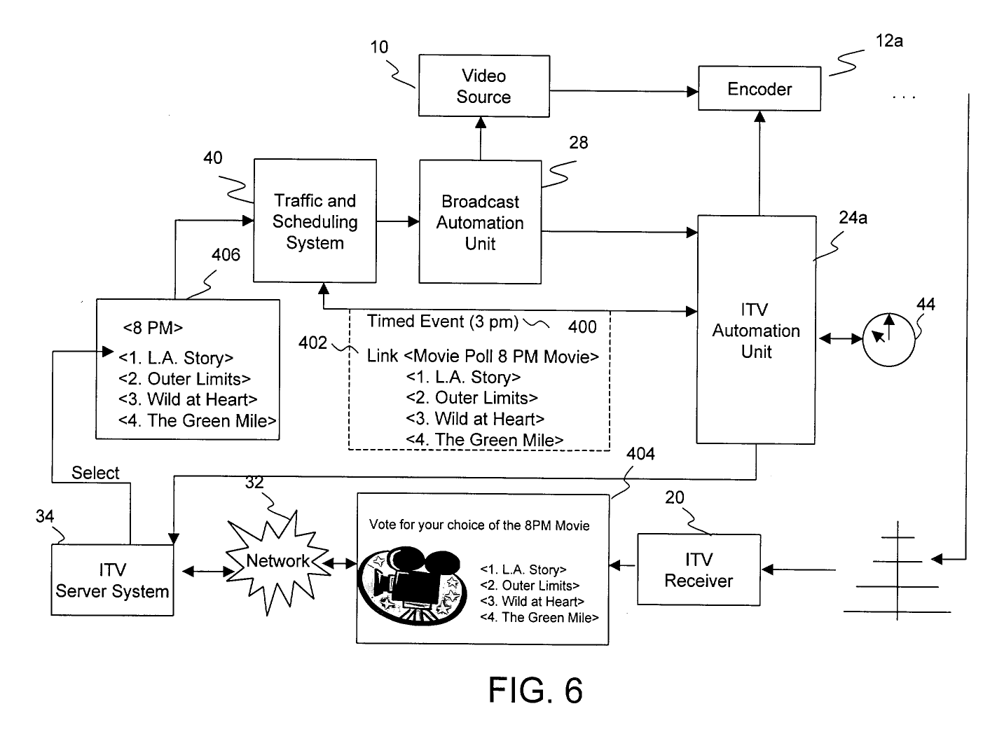

FIG. 6 is yet another exemplary use of the ITV system 50 of FIG. 2 according to an embodiment of the invention. At times predetermined by the traffic and scheduling system, a timed event 400 is provided to insert a viewer poll link 402 into the broadcast signal. The poll may be for selection of a movie for the 8 pm program slot. The poll may be provided in sync with an advertisement or television program, at an arbitrary time, or according to the viewer interest list 304.

Upon receipt of the encoded broadcast signal by the ITV receiver, the poll is displayed on the viewer's television set 404. The viewer may then vote on the upcoming 8pm movie. The viewer's vote is transmitted over the network connection 32 to the ITV server system 34 or a separate head end. The ITV server system or separate head end calculates the results of the poll and determines which movie has received the most votes. In the present example, L.A. Story is chosen as having received the most votes. L.A. Story is therefore scheduled for airing during the 8pm program slot by inserting it into a schedule file 406 of the traffic and scheduling system 40. When it is time to broadcast the 8pm movie, a video feed for L.A. Story is provided to the video source 10 for causing it to be broadcast to the viewers. In another embodiment, the ITV automation unit 24a may communicate with the ITV server system 34 and the ITV server system 34 may then communicate with the ITV receiver 20 to distribute the ITV content in this manner.

Although this invention has been described in certain specific embodiments, those skilled in the art will have no difficulty devising variations to the described embodiment which in no way depart from the scope and spirit of the present invention. Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. An interactive television (ITV) system comprising:
means for receiving a playlist of ITV events;
an automation unit coupled to the means for receiving, the automation unit obtaining ITV data associated with the ITV events in the playlist; and
an encoder coupled to the automation unit, the encoder configured to encode the ITV data into a broadcast signal in accordance with the playlist of ITV events.

2. The system of claim 1, wherein the playlist includes timing information of the ITV events.

3. The system of claim 1, wherein the automation unit translates the ITV events into encoder commands and associated ITV data and transmits the encoder commands and data to the encoder.

4. The system of claim 1, wherein the automation unit receives encoder commands and ITV data from an ITV server and transmits the commands and data to the encoder.

5. An interactive television (ITV) system comprising:
means for receiving a playlist of ITV events;
means for retrieving from the playlist timing information associated with the ITV events; and
means for coordinating at least one of the ITV events with a television program based on the retrieved timing information.

6. The system of claim 5, wherein the means for coordinating the ITV event comprises:
means for retrieving ITV data associated with the ITV event; and
means for encoding the ITV data into a broadcast signal.

7. An interactive television (ITV) system configured to generate a playlist of television programs to be broadcast during a particular period of time, the ITV system comprising:
an ITV automation unit receiving information on an ITV event and generating an encoder command in response, the information on the ITV event being transmitted to the ITV automation unit independently of the playlist of television programs; and
an encoder coupled to the ITV automation unit, the encoder encoding ITV data associated with the ITV event into a broadcast signal in response to the encoder command.

8. The system of claim 7, wherein the ITV event is defined in terms of a wall time.

9. The system of claim 7, wherein the ITV event is dynamically modified based on viewer interaction information.

10. An interactive television (ITV) system configured to generate a playlist of television programs to be broadcast during a particular period of time, the ITV system comprising:
means for receiving information on an ITV event independently of the playlist of television programs;
means for generating a command associated with the ITV event; and
means for synchronizing the ITV event with a television program based on the command.

11. The system of claim 10, wherein the ITV event is defined in terms of a wall time.

12. The system of claim 10, wherein the ITV event is dynamically modified based on viewer interaction information.

13. A method for providing an interactive television (ITV) program, the method comprising:
receiving a playlist of ITV events;
obtaining ITV data associated with the ITV events in the playlist; and
encoding the ITV data into a broadcast signal in accordance with the playlist of ITV events.

14. The method of claim 13, wherein the playlist includes timing information of the ITV events.

15. The method of claim 13 further comprising translating the ITV events into encoder commands and associated ITV data and transmitting the encoder commands and data to the encoder.

16. The method of claim 13 further comprising receiving encoder commands and ITV data from an ITV server and transmitting the commands and data to the encoder.

17. A method for providing an interactive television (ITV) program, the method comprising:
receiving a playlist of ITV events;
retrieving from the playlist timing information associated with the ITV events; and
coordinating at least one of the ITV events with a television program based on the retrieved timing information.

18. The method of claim 17, wherein the coordinating of the ITV event comprises:
retrieving ITV data associated with the ITV event; and
encoding the ITV data into a broadcast signal.

19. In an interactive television (ITV) system configured to generate a playlist of television programs to be broadcast during a particular period of time, a method for providing an ITV television program comprising:
receiving information on an ITV event independently of the playlist of television programs;
generating a command associated with the ITV event; and
synchronizing the ITV event with a television program based on the command.

20. The method of claim 19, wherein the ITV event is defined in terms of a wall time.

21. The method of claim 19, wherein the ITV event is dynamically modified based on viewer interaction information.
